(19) United States
(12) Patent Application Publication
(10) Pub. No.: US 2008/0222102 A1
(43) Pub. Date: Sep. 11, 2008

(54) Method, apparatus and computer program product for providing a customizable safety management center

(75) Inventor: Lloyd Hanson, Cary, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Martin Marietta Materials, Inc.

(21) Appl. No.: 11/714,025

(22) Filed: Mar. 5, 2007

(51) Int. Cl. G06F 17/30

(52) U.S. Cl. 707/3; 707/E17.014

(57) ABSTRACT

An apparatus for providing a safety management center includes a communication element, a memory device, a reporting element and a planning element. The communication element is configured to receive safety related event data via an event record that is customizable at a plurality of levels within an organization. The memory device is in communication with the communication element for storing the event data. The reporting element is in communication with the memory device and is configured to generate a report based on the stored event data. The report is customizable at the plurality of levels within the organization. The planning element is in communication with the memory device and the reporting element and configured to generate planning information for improving projected future reports. The planning information is also capable of generation at each of the plurality of levels within the organization.

### FIELD OF THE INVENTION

Embodiments of the present invention relate generally to safety management techniques, and more particularly, to providing a safety management center capable of managing safety related information from multiple sources.

### BACKGROUND OF THE INVENTION

Many organizations have taken a strong interest in increasing organizational productivity. Such increases are achieved in numerous ways including streamlining procedures, improving equipment, improving worker training, improving safety, reducing waste, reducing downtime, etc. As a result, numerous organizations have developed programs aimed at monitoring one or more of the areas described above. For example, programs have been created for monitoring safety related issues within a particular organization.

The ubiquitous nature of computers and their relatively vast processing capabilities have led to the utilization of applications which can be executed by computers to perform safety related monitoring programs. In this regard, applications have been developed to assist in the creation and tracking of reports of mishaps, incidents, accidents, etc. However, advancements in certain areas may have positive impacts on other areas related to safety. For example, improving worker training may lead to a reduction of injury related accidents and/or equipment downtime. Additionally, many organizations are relatively large in size and run operations that are diverse, thereby making it difficult to manage and correlate safety related data on an organization wide basis. For example, particular divisions within an organization may be involved in completely different operations. Thus, the organization may be forced to create unique safety monitoring programs for each division or even unique safety monitoring programs within work centers of the same division. Management of differing programs may become difficult and many potential benefits may be lost due to inefficiencies in the management tool such as a rigid structure that is insufficiently flexible to permit managing diverse organizational safety issues. For example, details at each corresponding divisional level may not be capable of reporting using similar reporting mechanisms and thus, details may be lost in translating divisional related information into a form that is useable at the organizational level.

Accordingly, it may be desirable to introduce a robust and customizable safety center management tool that is capable of improving current safety management techniques.

### BRIEF SUMMARY OF THE INVENTION

Accordingly, in order to address the problems described above, embodiments of the present invention may provide a method, apparatus and computer program product for providing a safety management center at an organizational level that includes further customizable characteristics that make the safety management center scalable to any sized organization regardless of the operations of each division of the organization. The safety management center also includes a drill down capability, such that links are provided from one organizational level to the next within each reporting module. Additionally, each reporting module may be linked to reporting modules of different types so that safety related event records of varying types and corresponding reports may be accessed from a single web page. Accordingly, organization wide safety management may be accomplished in a web based environment rather than via a paper based or other environment. Furthermore, it may be possible for the safety management center to identify particular areas of need or to recommend particular alterations to current operations based on organizational trends determined from internally or externally generated safety related information.

In one exemplary embodiment, a method for providing a safety management center is provided. The method includes receiving safety related event data via an event record that is customizable at a plurality of levels within an organization, storing the event data, generating a report based on the stored event data, and generating planning information for improving projected future reports. The report is customizable at the plurality of levels within the organization. The planning information is capable of generation at each of the plurality of levels within the organization.

In another exemplary embodiment, an apparatus for providing a safety management center is provided. The apparatus includes a communication element, a memory device, a reporting element and a planning element. The communication element is configured to receive safety related event data via an event record that is customizable at a plurality of levels within an organization. The memory device is in communication with the communication element for storing the event data. The reporting element is in communication with the memory device and is configured to generate a report based on the stored event data. The report is customizable at the plurality of levels within the organization. The planning element is in communication with the memory device and the reporting element and configured to generate planning information for improving projected future reports. The planning information is also capable of generation at each of the plurality of levels within the organization.

In another exemplary embodiment, a computer program product for providing a safety management center is provided. The computer program product includes at least one computer-readable storage medium having computer-readable program code portions stored therein. The computer-readable program code portions include first, second, third and fourth executable portions. The first executable portion is for receiving safety related event data via an event record that is customizable at a plurality of levels within an organization. The second executable portion is for storing the event data. The third executable portion is for generating a report based on the stored event data. The report is customizable at the plurality of levels within the organization. The fourth executable portion is for generating planning information for improving projected future reports. The planning information is capable of generation at each of the plurality of levels within the organization.

Embodiments of the invention provide an increased ability to manage safety related information at all levels within an organization. Information may be provided via a customizable interface that ensures that all information reported may be utilized in conjunction with not only the particular level with which the information was originally associated, but also with all other levels of the organization. Additionally, such information may be available in an organization wide environment. As a result, safety may be further increased and organizational productivity may be enhanced.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram illustrating a system for providing a safety management center in accordance with an exemplary embodiment of the present invention;

FIG. 2 illustrates a functional block diagram of the safety management center according to an exemplary embodiment of the present invention;

FIG. 3 is a screen shot of an exemplary web page for accessing and/or entering information for safety management according to an exemplary embodiment of the present invention;

FIG. 4 shows an exemplary data entry page corresponding to a particular event or incident according to an exemplary embodiment of the present invention;

FIG. 5 shows an exemplary web page for an event record according to an exemplary embodiment of the present invention;

FIG. 6 shows an exemplary web page generated responsive to entry of particular search criteria according to an exemplary embodiment of the present invention;

FIG. 7 shows an example of a screen shot for a safety overview page according to an exemplary embodiment of the present invention;

FIG. 8 shows an example of a screen shot for a report issued by a reporting element according to an exemplary embodiment of the present invention;

FIG. 9 shows an example of a screen shot for a recommendation report issued by a planning element according to an exemplary embodiment of the present invention; and

FIG. 10 shows a flowchart of a system and method for providing a safety management center according to an exemplary embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout.

As background, it should be understood that embodiments of the present application are designed to be implemented to enable the recording of information related to events or incidents that are associated with a safety management program such as in a web based environment. Subsequently, the information recorded is used for generating reports and for assisting in the management of safety within an organization. The events may include incidents which relate to safety or observations or inspections made by personnel either within or outside the organization. Concerns (i.e., safety related issues noted during an observation or inspection) generated as a result of the observations or inspections, and comments regarding the incidents may be recorded and used to provide various kinds of analysis as described below.

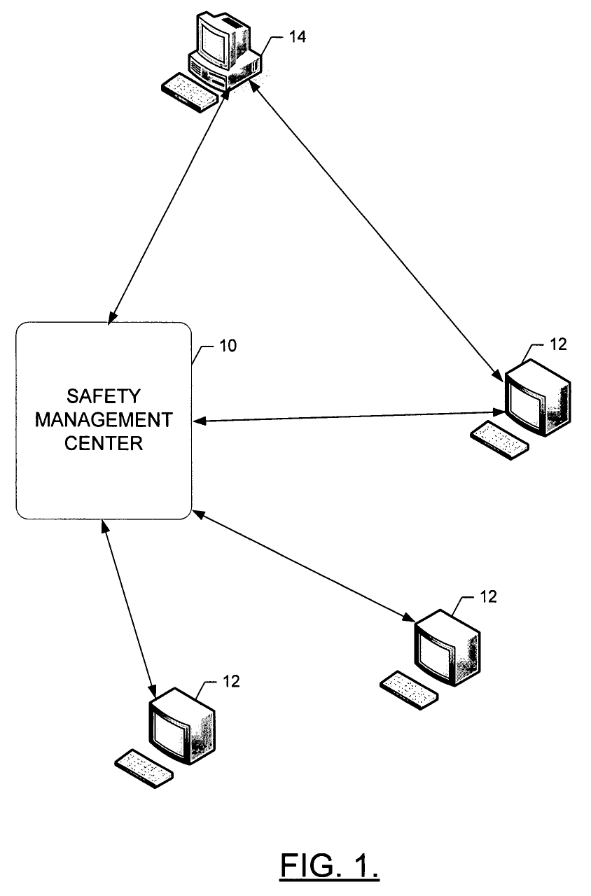

FIG. 1 is a diagram illustrating a system for providing a safety management center in accordance with an exemplary embodiment. A safety management center 10 may be embodied as any device or means embodied in either hardware, software, or a combination of hardware and software that is capable of managing safety related information from internal and/or external sources. In an exemplary embodiment, the safety management center 10 may be embodied as a web server capable of serving a plurality of client stations. As shown in FIG. 1, the safety management center 10 may be in communication, via either a wired or wireless connection, with one or more client stations 12. In this regard, the client stations 12 and the safety management center 10 may be part of a network such as a LAN corresponding to a particular organization. As such, from the perspective of the organization, the client stations 12 may be considered internal devices and any information or data input at one of the client stations may be considered to be internally generated information.

In an exemplary embodiment, one or more of the client stations 12 may be associated with different organizational levels within the particular organization. For example, one or more of the client stations 12 may be associated with a division within the organization, while remaining ones of the client stations 12 are each associated with respective different divisions. Alternatively, some of the client stations 12 may be associated with different respective divisions, while others of the client stations 12 may be associated with different respective regions comprising multiple divisions each. Yet other client stations 12 could be associated with the organizational level. As such, each of the client stations 12 may be located in different physical locations. However, regardless of the physical location of each of the client stations 12, access may be provided with access to the safety management center 10 via the client stations 12.

Each of the client stations 12 may be, for example, a computer or other device capable of providing a user interface which enables access to the safety management center 10 for the purposes of performing various operations associated with the safety management center 10 such as inputting, viewing, modifying or editing information. As such, the client stations 12 may include input devices such as, for example, a keypad, keyboard, mouse, touch screen display or any other suitable input device and output devices including any of a display, a printer, a facsimile, etc. The client stations 12 may also be in communication with external devices, for example, via email, or via other communication networks. The client stations 12 may communicate with the external devices to receive safety related information or data from an external source 14 or to communicate information to the external source 14. Accordingly, the client stations 12 may act as a gateway for information or data either being sent to the safety management center 10 from the external source 14 or being sent to the external source 14 from the safety management center 10. Alternatively, the safety management center 10 may be capable of communicating with the external source 14 directly in order to send or receive information or data to or from the external source 14.

In an exemplary embodiment, the external source 14 may include an entity having regulatory oversight over the organization. For example, the external source 14 could include one or more of the Occupational Safety and Health Administration (OSHA), the Mine Safety and Health Administration (MSHA), etc. and the safety management center 10 could receive citations, inspection information, or nationwide statistical data from the external source 14. Additionally or alternatively, the safety management center 10 may submit reports to the external source 14.

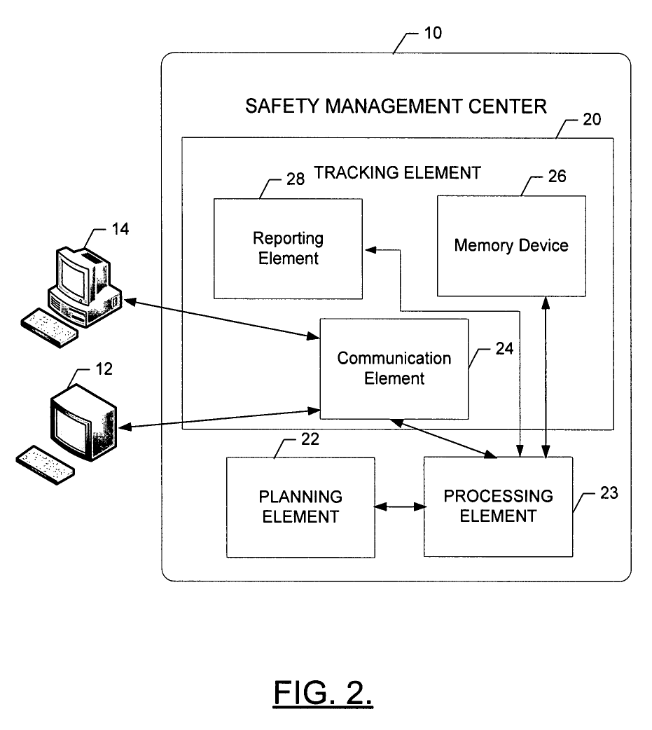

FIG. 2 shows a functional block diagram of the safety management center 10 according to an exemplary embodiment. As shown in FIG. 2, the safety management center 10 includes a tracking element 20 and a planning element 22, which both operate under the control of or in response to a processing element 23. The processing element 23 may be embodied in many ways. For example, the processing element 23 may be embodied as a processor, a coprocessor, a controller or various other processing means or devices including integrated circuits such as, for example, an ASIC (application specific integrated circuit). The tracking and planning elements 20 and 22 may each be embodied as any device or means embodied in either hardware, software, or a combination of hardware and software that is capable of performing the corresponding functions associated with the tracking and planning elements 20 and 22 as described below.

In an exemplary embodiment, the tracking element 20 may be configured to receive internally generated information input at any of the client stations 12 and/or externally generated information input from the external source 14. The tracking element 20 may also be configured to output reports to any of the client stations 12 and/or the external source 14 and to output recommendations to any of the client stations 12. As shown in FIG. 2, the tracking element 20 may include a communication element 24, a memory device 26, and a reporting element 28.

The communication element 24 may be configured to enable communication of the internally and/or externally generated information to the tracking element 20 and to enable the tracking element 20 to communicate reports and/or recommendations to the external sources 14 and/or the client stations 12. For example, if MSHA is one of the external sources 14, the communication element 24 may conduct communications with an entity at MSHA to receive citations issued by MSHA and directed to the organization. Additionally or alternatively, the communication element 24 may receive inspection results from MSHA, which are directed to the organization. In an exemplary embodiment, the communication element may also receive statistical data from MSHA that includes nationwide statistics related to the particular industry or area of regulatory oversight which MSHA provides. For example, the nationwide statistics may include information on numbers and/or types of citations issued to other organizations that are conducting similar operations. As such, the organization may use the nationwide statistics to determine how the organization compares to the other organizations in certain safety related areas. The communication element 24 may also be capable of communicating reports to MSHA. As such, periodic reports regarding information on man hours or other reportables may be submitted from the safety management center 10 directly to MSHA via the communication element 24. In this regard, the entity at MSHA may receive the reports via the web or the reports may be sent via email or any other suitable electronic communication mechanism. For example, the 7002 quarterly report may be submitted via the communication element 24. It should be noted that, although the above description refers specifically to MSHA, the external sources 14 could include OSHA or organizations including other regulatory organizations. It should also be noted that although the description above refers to direct communication between an entity at MSHA and the communication element 24, reports may also be sent to MSHA via one of the client stations 12, such as via email.

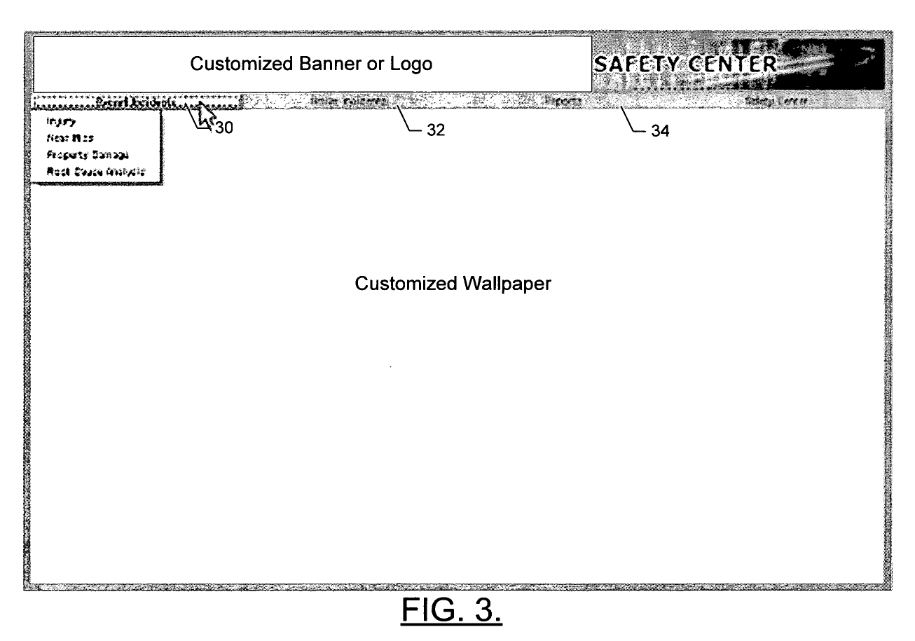

Internally generated information provided to the tracking element 20 may be provided, for example, by any of the client stations 12. In an exemplary embodiment, internally generated information may be provided via a web page such as the one shown, for example, in FIG. 3. As shown in FIG. 3, generation of the internally generated information may be initiated using, for example, a drop down menu or any other suitable user interface. The internally generated information may include safety related information or data that is reported or recorded corresponding to a particular incident. Accordingly, by selecting a drop down menu corresponding to event recording (e.g., by selecting the “report incidents” tab 30), the user may access forms for data entry (i.e., data entry pages) corresponding to various types of events. As used herein, the term “event” should be understood to encompass any accident, incident, injury, near miss, property damage, or observation that is being recorded or reported into the system. Thus, by selecting an item from the drop down menu that corresponds to the event to be reported, the user may be directed to a data entry page corresponding to the event to be reported.

The events listed in the drop down menu may be customizable by the organization. In other words, authorized personnel at the organization may edit, modify, or otherwise customize the event reporting tab so that the events that are reportable may be selected to correspond to the types of events that are expected to be encountered and/or desired to be reported on by the organization. Furthermore, customization of features may be performed at each level within the organization. In other words, each division may have customized data entry pages that accurately reflect the operations of the division. For example, data entry pages for observations in a division that conducts mining operations using heavy equipment and tools may include questions related to machinery maintenance and/or tool condition. Meanwhile, a division that conducts human resource management may have no use for such questions and therefore may customize their data entry pages for observations to include more relevant questions.

Customization of features of the safety management center 10 may be performed at the client stations 12. For example, the organization may define different levels of authorization which are assigned to various different people, groups, or units within the organization. For example, each of the client stations 12 may require a user name and password or some other form of login in order to identify the individual accessing the safety management center 10 and grant access at the respective level that is preset for the individual. The different levels of authorization may then define the extent to which access is afforded to the individual. For example, if the individual is a technician or laborer, the individual may have access to view active incidents and reports organization wide, but may only be able to report new events for the individual's division with limited access to fields within the data entry page. Meanwhile, if the individual is a supervisor or a safety manager, a higher level of authorization may be provided. As such, the individual may have access to view active incidents and reports organization wide and to report new events in multiple respective divisions and perform root cause analysis or prescribe corrective actions. Additionally, if the individual is safety management center management staff, the individual may have authorization to modify the look and feel of the safety management center 10 web service by, for example, customizing the user interface including the drop down menus and data entry pages.

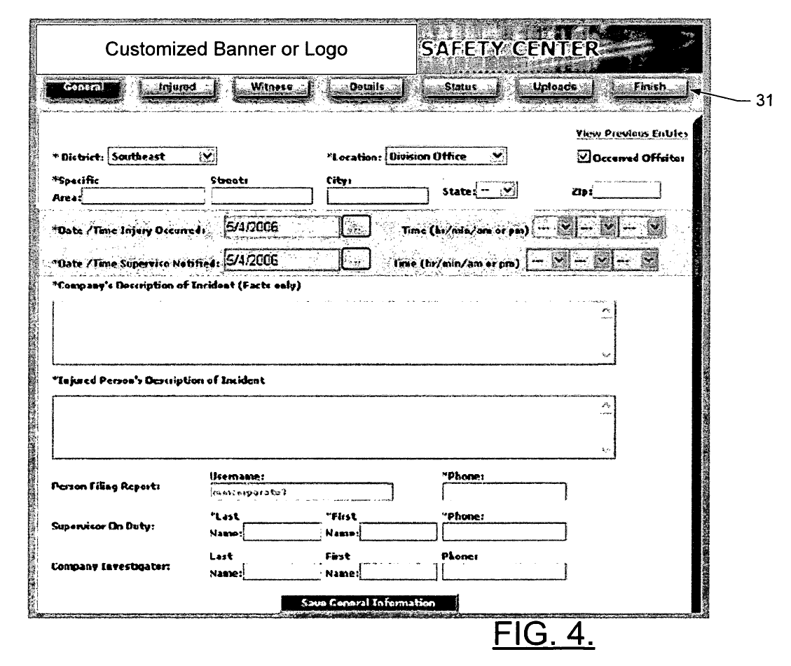

FIG. 4 shows an exemplary data entry page corresponding to a particular event or incident. However, it should be noted that, as stated above, the data entry page is customizable in order to correspond to needs or desires of the organization and thus, the data entry page of FIG. 4 is merely exemplary. As shown in FIG. 4, the data entry page may include various fields for data entry including fields for information such as the organizational unit at which the event occurred, the time and date of the event, the type of event, a description of the event from the perspective of the organization, the participants, and/or witnesses. Fields for receiving other information may also be provided, such as the supervisor, investigator, identity of the creator of the entry, etc. Once data entry is finished, the data entry page may be saved to the memory device 26 under a unique identification number such as a tracking number as an event record (i.e., “active incident”).

As shown in FIG. 4, the data entry page may include an indication of which fields are required to be completed. For example, an asterisk may be used to indicate required fields. The data entry page may also include a link to previous entries. In an exemplary embodiment as shown in FIG. 4, the data entry page may actually comprise a series of related pages, each of which is accessible from any page of the series as indicated by the function buttons 31 displayed below the banner of FIG. 4. In this regard, each of the function buttons 31 may be associated with a related page devoted to a particular topic related to the overall task of data entry for an event. For example, the witness function button may provide a link to a page devoted to gathering witness information, the status function button may provide a link to a page devoted to status information related to the event, etc.

Each type of event may have a particular corresponding data entry page. Furthermore, the data entry page for each type of event may be customizable. For example, an observation data entry page may include a section for identifying concerns witnessed during the observation. Meanwhile a near miss data entry page may include a section for estimating the foreseeable damage that could have occurred, such as a type of contact activity as determined by a supervisor or safety manager. An injury data entry page may include details regarding the injury such as the contact activity that occurred (i.e., loss of footing, electric shock, puncture wound, etc.) and lost man hours. Additionally, as stated above, each organizational level within the organization may customize its own data entry pages in order to ensure that the data entry pages have improved applicability for each corresponding organizational level. However, regardless of the type of event, each data entry page also includes common or comparable items that may be used for providing trend data and trend analysis at all organizational levels. The comparable items may include the time, the date, the day of the week, the location or organizational level, supervisor, etc.

The memory device 26 may include both volatile and non-volatile memory of any suitable type. As such, the memory device 26 may store data and information received from either the client stations 12 or the external source 14. As such, for example, the volatile memory may be used for temporary storage of data used in report generation, while the non-volatile memory is used for long term storage of event records. The memory device 26 may also store reports and/or recommendations prior to the output of the reports and/or recommendations at the client stations 12 or the external source 14. In an exemplary embodiment, the processing element 23 is capable of storing information received by the communication element 24, reports generated by the reporting element 28, and recommendations generated by the planning element 22 in the memory device 26. The processing element 23 is also capable of accessing the stored information, reports, and/or recommendations from the memory device 26 for communication of the stored information, reports, and/or recommendations via the communication element 24.

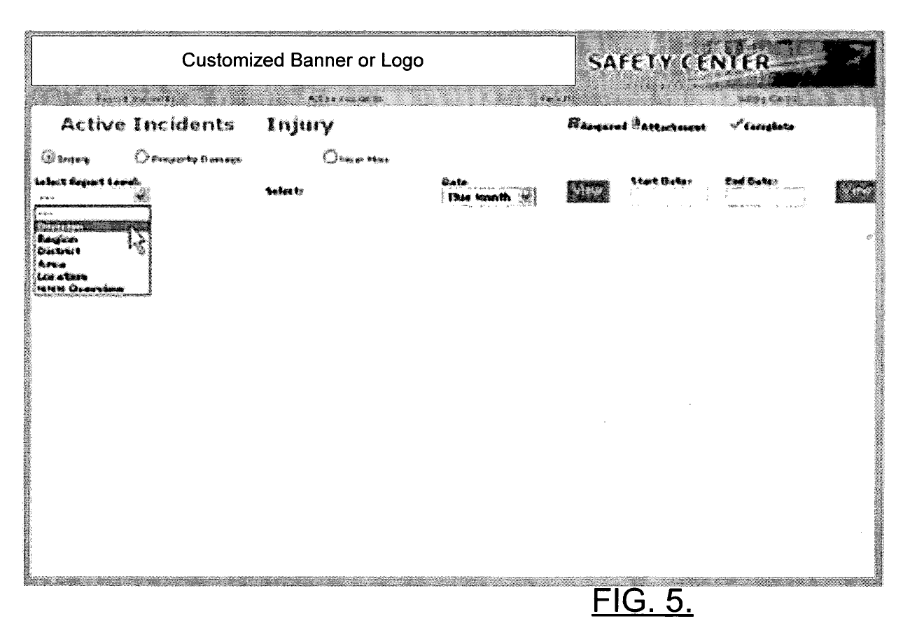

The reporting element 28 may be embodied as any device or means embodied in either hardware, software, or a combination of hardware and software that is capable of generating reports based on received information. In this regard, the reporting element 28 receives internally and/or externally generated information and generates reports based on the information received. The reporting element 28 also manages active incidents that have been created in response to saving of a data entry page after reporting an event. Thus, for example, when a data entry page is utilized to report an event, an active incident or event record is created corresponding to the information provided during reporting of the event on the data entry page. For example, when the data entry page is saved, a unique tracking number may be assigned to the event. Tracking numbers may be organized, for example, by the type of the event (i.e., observation, inspection, near miss, injury, property damage, etc.), the organizational unit in which the event occurred, etc. As stated above, the data entered via the data entry page may be stored in the memory device 26 in the form of an event record and therefore be accessible at a later time, for example, via the tracking number or via a search. As such, information regarding the event may be recalled at a later time using the tracking number, for example, by selecting the “active incidents” tab 32 shown in FIG. 3. In an exemplary embodiment, selecting the active incidents tab 32 may provide a web page such as is shown in FIG. 5. The web page may be utilized to enter search criteria to find a listing of active incidents which may be displayed according to the tracking number of incidents meeting the search criteria. The web page may also enable the user to select a particular type of event for which to search. For example, the user may be prompted to select an observation, an injury incident, a property damage incident, a near miss, etc. Some exemplary search criteria could include the organizational level to be searched. For example, the organizational level could be a division, region, district, area, location, etc. A particular unit within the selected organizational level may be further designated as search criteria. A specific date or a date range may also be specified.

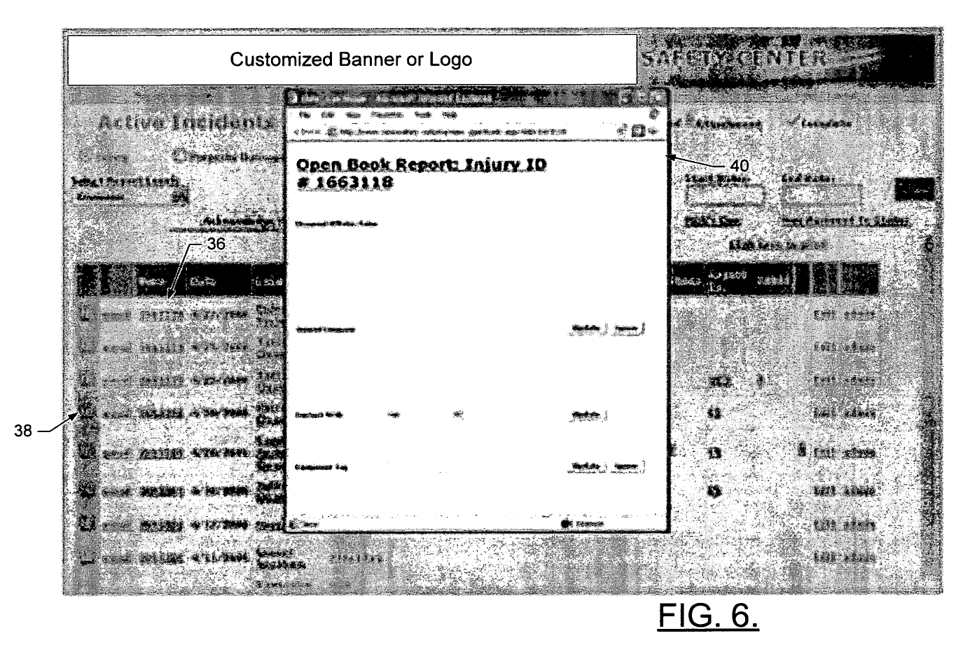

FIG. 6 shows an exemplary web page generated responsive to entry of particular search criteria according to an exemplary embodiment of the present invention. As shown in FIG. 6, a list of events corresponding to the search criteria may be provided according to tracking number 36. Each event in the list of events may include an associated identifier or icon 38 indicating a state of the corresponding event. For example, the icon 38 may be an open book indicating that the event record has required fields that have not yet been filled in. In this regard, when the data entry page is being completed, it is possible for the creator of the data entry page to save the event to the memory device 26 prior to providing an entry for every field of the data entry page. Thus, if all facts or information are not known at the time of the event, the creator is not precluded from being able to record the event and have the event entered into the safety management center 10 for processing. Rather, the event may be recorded and the icon 38 (e.g., the “open book” icon) may be used to indicate that further information may be required to complete the entry. When a response or entry is recorded for every field of the data entry page, the icon 38 may indicate that no further data is required for the entry, for example, by presenting a “closed book” icon. In this regard, each field may invite a response in the form of text or data, or an alternative input such as “not applicable” or “ignore”. During customization of the safety management center 10, the organization may define both which fields should appear in the data entry page and which, if any, of the fields for which a response of “not applicable” or “ignore” is an acceptable input.

In an exemplary embodiment, selection of the “open book” icon may open an information and control console 40 generated specifically to identify only those fields that have not yet received an input and enable the user to input data into the corresponding fields. As such, when all of the fields have an input, the icon 38 may change to the “closed book” icon. It should be noted that the creator of the event (i.e., the individual who saved the completed data entry page) need not be the same as the user that enters information for a corresponding active incident. For example, a supervisor may complete a data entry page for a particular incident by saving the data entry page with inputs in all fields except the investigator field. At a later time, a safety manager may assign an investigator and, by selecting the “open book” icon, access the information and control console 40 to input the investigator, which may then change the icon 38 to the “closed book” icon when the additional data is entered, thereby completing the entry for the corresponding event record or active incident.

The reporting element 28 also enables the user to generate, view or output reports that are generated based on the information provided in the active incidents. As such, it should be noted that all active incident data is used in preparing reports, whether the active incident data corresponds to an “open book” entry or a “closed book” entry. The reporting element 28 provides analysis of information received by the tracking element 20 based on organizational hierarchy and selected date ranges. In an exemplary embodiment, reports may be accessed via a “reports” tab 34 which may provide a drop down menu or a separate web page for selecting or otherwise identifying desired reports for viewing. In this regard, reports may be selected based upon organizational level, date range or other suitable factors. Each report may also include a drill down capability into more detailed information of corresponding selected areas and/or links to similar reports corresponding to other divisions, regions, locations or other organizational levels.

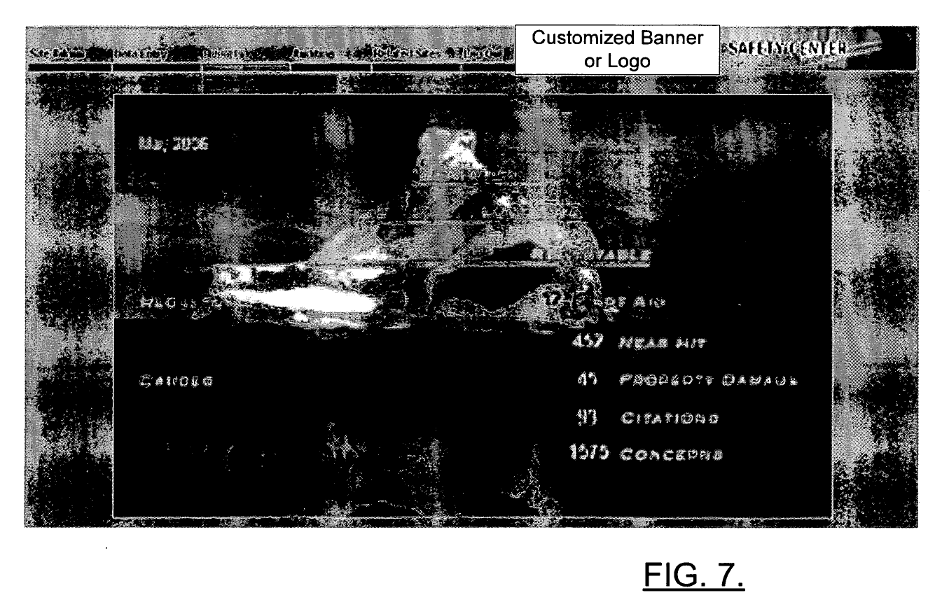

In an exemplary embodiment, the safety management center 10 may provide a safety overview page such as is shown, for example, in FIG. 7. As such, the safety overview page may report totals for each different type of active incident (i.e., accidents, injuries, observations, citations, etc.) for the entire organization over the selected date range. By selecting any particular type of active incident on the safety overview page, a more detailed report for the particular type of active incident may be displayed. The more detailed report may include, for example, graphical reports (e.g., charts, graphs, etc.) that may be emailed, printed, saved, etc. directly from the web page. The more detailed report may also provide other comprehensive analysis that may be useful in analyzing the effectiveness of the organization's safety management program such as trend data. Trend data may be provided using the comparable data in each event record in order to indicate, for example, rates of concerns and incidents or citations. Trend data may be useful in predicting future performance in certain areas, since trend data typically reports rates of occurrence of corresponding events. Additionally, trend data may be used to show various different reports on a single graph in order to analyze the impact of one event's rate of occurrence upon the rate of occurrence of another type of event. The more detailed report may alternatively include the same information provided by the safety overview page except that the information is only provided from a particular unit within a different organizational level (i.e., a particular region, division, location, etc.). The more detailed report may also provide a list of the active incidents of the particular type for the corresponding organizational level during the selected time period.

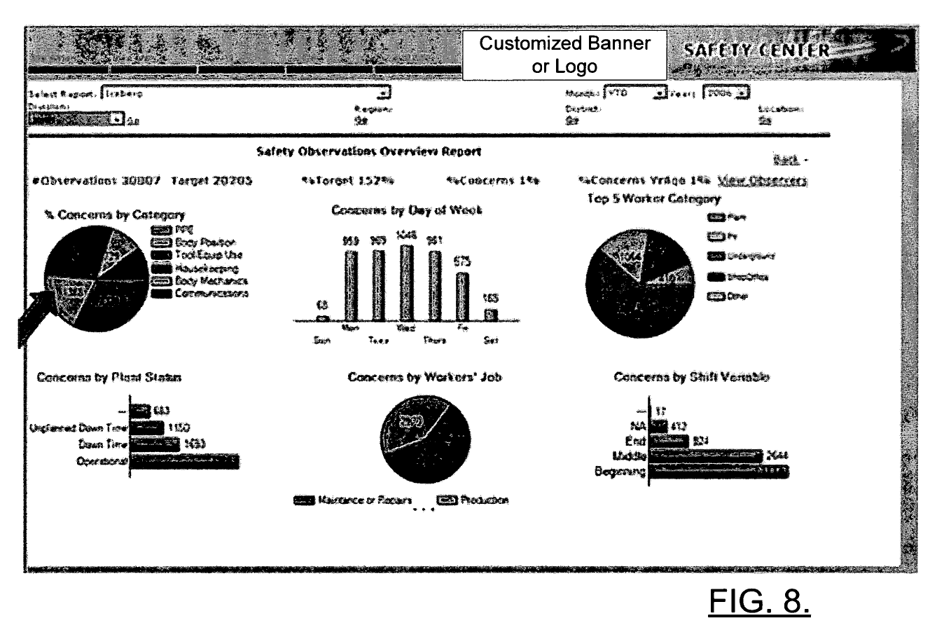

An exemplary report is shown in FIG. 8, however, it should be noted that the report of FIG. 8 is offered merely for purposes of example and not of limitation since the reports may take numerous forms. As shown in FIG. 8, a report may be selected to correspond to any unit at any organizational level within the organization and any selected date or date range. As shown in FIG. 8, the reporting element 28 is capable of analyzing event reports corresponding to a selected date range in order to generate various types of graphical representations of event rates (i.e., the rate of occurrence of a particular event), categories of events, events by job title, events by shift timing, events by plant status, comparisons of percentages to other selectable periods of time, etc.

The tracking element 20 may also be configured to incorporate root cause and corrective action data. For example, the data entry page and/or the active incident associated with each event may include a section for root cause/corrective action analysis as appropriate. In an exemplary embodiment, injury, near miss and property damage events may include both root cause and corrective action analysis. Meanwhile, citations and concerns from observations or inspections may only include corrective actions. Accordingly, for example, a particular division in receipt of a citation may utilize the tracking element 20 to search for similar citations that may have been received in other organizational units, such as another division. The particular division may then model their response to the citation upon the corrective actions utilized in response to the citation received at the other organizational unit. This may be especially useful in situations where the prior corrective actions eventually proved to be successful.

The planning element 22 may be configured to analyze information and data included in the active incidents and provided by internally and/or externally generated information in order to provide a predictive assessment related to the incidence of future concerns and/or incidents. The planning element 22 may also or alternatively be configured to provide recommendations for improving safety management such as by improving the predictive assessment based on data associated with currently stored events (i.e., concerns and/or incidents).

The predictive assessment may be generated based on current trend data and/or a current observation plan. The current observation plan may include a schedule indicating the dates and times, or ranges of dates and times during which future observations are expected to be conducted. In this regard, the current observation plan may include both random and scheduled observations and inspections. As such, the planning element 22 may be capable of recognizing patterns and trends related to the occurrence of events under the current observation plan and predicting the likelihood of future occurrences. In this regard, the predictive assessment may include a graphical representation of the likelihood of future occurrences of concerns and incidents at a time period selected by the user.

As stated above, the planning element 22 may also provide recommendations for improving safety management. In this regard, the planning element 22 may identify patterns and/or trends in concerns or incidents and, based on the patterns and/or trends, the planning element 22 may provide recommendations for improving safety management. The planning element 22 may analyze and determine trends based on various characteristics such as temporal characteristics (e.g., day of the week, time of day, etc.), substantive characteristics (e.g., type of concern or incident), or geographic considerations (e.g., facility at which the concern or incident occurred). For example, the planning element 22 may be capable of identifying that the majority of observations are conducted at a particular time, or on a particular day of the week or month, while a majority of incidents are occurring at a different time, day of the week or month. Accordingly, the planning element 22 may provide a recommendation to modify the observation plan to, for example, shift scheduled observations to correspond to periods during which incident occurrence is more likely or just prior to periods in which incident occurrence is more likely. A general assumption that may be employed by the planning element 22 may be that an increase in noted concerns and corresponding corrective actions is likely to decrease the occurrence rate of incidents. In other words, concern rates (i.e., the rate at which particular concerns occur over a given time period) and incident rates are likely to be inversely proportional within a particular area of operation. Accordingly, recommendations may be made regarding the frequency of observations, the timing of observations or even the questions associated with performance of a particular observation. For example, recommendations may be made that a particular question should be added based on events which occur that are related to a particular observation. For example, if a maintenance activity is monitored with a set of questions related only to the actual maintenance and yet housekeeping and cleanliness comments are routinely received in citations from external sources, a recommendation may be made to modify the questions to include a question stating, “Is the worksite clean?”.

The planning element 22 may also be capable of identifying that particular questions associated with the performance of a particular observation are not adequate or are not being observed and thereafter recommend changing the questions or enforcing their observation. Questions associated with observations may include, for example, questions regarding the condition of tools used, the cleanliness of a work environment, the proper use of tools by a technician, etc. Thus, for example, if a number of property damage incidents or injuries occur due to tool breakage, the planning element 22 may identify discrepancies such as the failure of observers to comment on a question related to the condition of tools. Alternatively, if all observers commented positively on the condition of tools, the planning element 22 may recommend training on identifying tool deficiencies, or stressing the question during an observation since the area is a problem area. In this regard, the planning element 22 may evaluate the questions to determine, for example, if a certain percentage of the questions appear to be ineffective then the questions should be changed, or if a certain percentage of the questions are routinely failed or answered in a fashion indicative of unacceptable practices, then training should be conducted. In an exemplary embodiment, the planning element 22 may include a list of candidate questions which may be used as recommended questions in corresponding situations. For example, the candidate questions could be questions installed by developers or questions utilized by other units within the organization.

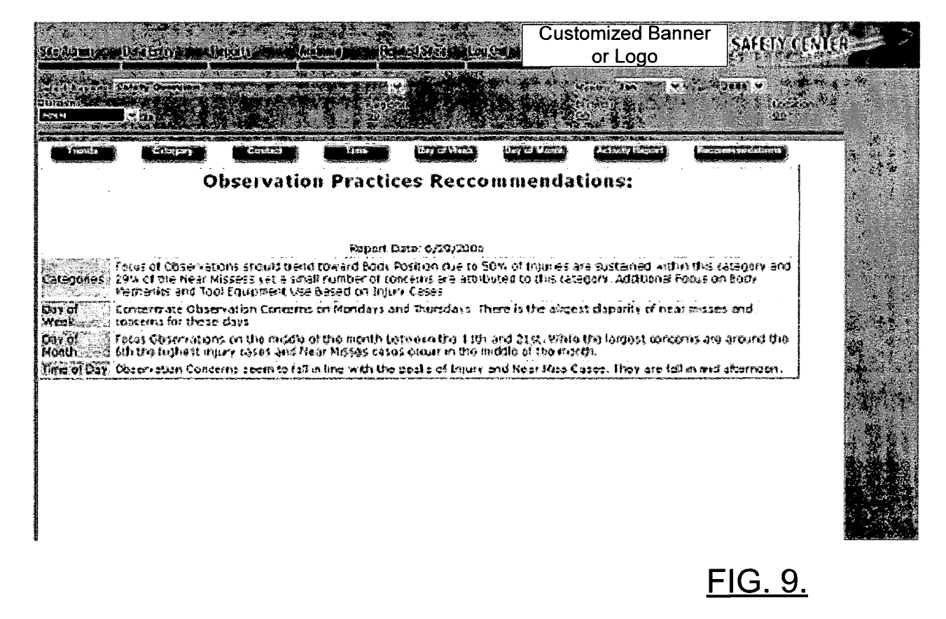

The planning element 22 may also identify training deficiencies or other similar operational shortcomings and provide appropriate recommendations. For example, if an individual such as a supervisor or another worker is involved in an incident that is outside the area of expertise or normal operation for the individual, the planning element 22 may provide suggestions to recommend that clearer boundaries be established to define the tasks in which each individual should participate. Alternatively, the planning element 22 may recommend that cross training should be provided to certain job titles that appear to be likely to be exposed to activity in areas otherwise considered outside the area of expertise or normal operation for the individual. FIG. 9 shows an example of a screen shot for a recommendation report issued by the planning element according to an exemplary embodiment of the present invention.

The planning element 22, like the tracking element 20, may be utilized at any organizational level within the organization for any particular unit within the organization. Thus, for example, recommendations may be provided at the organizational level based on organization wide data, or the recommendations may be provided at the divisional level based on division wide data, and all levels in between. Since each level may customize data entry, reports and recommendations are also customizable for each level. Such customization extends to substantive issues such as the questions associated with an observation data entry page and also to non-substantive issues such as the banner or the wallpaper associated with a particular division's data entry pages.

Accordingly, in general terms, the safety management center 10 according to an embodiment of the present invention includes an initial data entry mechanism that is customizable for each organizational level. Data entry need not result in every field of data entry pages associated with an event record being completed in order for the data that is entered to be used for analysis. Rather, complete or incomplete data may be assigned an identification such as the tracking number and an identifier associated with the identification for indicating to a user whether certain fields of the event record have or have not received an input. By selecting the icon, only those fields that have not yet received an input may be conveniently completed, thereby changing the identifier to indicate that all fields have received an input. Reports may be viewed based on internally and externally generated information and such reports may be output to either internal or external sources. The reports may correspond to any unit of the organization at any organizational level with links provided to expand to a subsequent higher level or to focus on a subsequent lower level of the organization. Predictions may be provided to indicate likely future concern and incident rates. The predictions may be based on stored data and current observation plan information. Recommendations may be provided based on improving the predictions or based on analysis of indicia of current deficiencies based, for example, on patterns and trends identified from stored information. In other words, the safety management center 10 may provide a robust capability for managing safety related issues by pulling together data from numerous sources over various types of events at all levels within an organization. Specifically, the safety management center 10 pulls together resources associated with root cause/corrective action analysis, with observation records, incident records and other event records to provide for the viewing or transmission of reports as well as the receipt of citations from regulatory entities in a single web based environment.

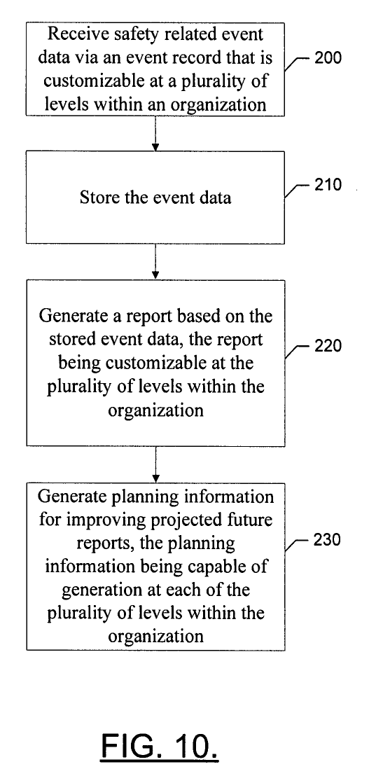

FIG. 10 is a flowchart of a system, methods and program products according to exemplary embodiments of the invention. It will be understood that each block or step of the flowchart, and combinations of blocks in the flowchart, can be implemented by various means, such as hardware, firmware, and/or software including one or more computer program instructions. For example, one or more of the planning element 22 and at least portions of the tracking element 20, such as the reporting element 28, may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing safety management, as shown in FIG. 7, may include receiving safety related event data via an event record that is customizable at each of a plurality of levels within an organization at operation 200. In an exemplary embodiment, operation 200 may include receiving event data from a source external to the organization such as from a regulatory agency. At operation 210, the event data may be stored. In an exemplary embodiment the event data may be stored with an associated identifier for indicating to a user whether certain fields of the event record have not received an input. A report may be generated based on the stored event data at operation 220. The report may be customizable at each of the plurality of levels within the organization. Generating the report may include generating trend data indicating rates of occurrence of event records. In an exemplary embodiment, the report may be provided to an external source such as a regulatory agency and the event data may be one of a citation or an inspection record. At operation 230, planning information may be generated for improving projected future reports. The planning information may be capable of generation at each of the plurality of levels within the organization. In exemplary embodiments, the planning information may include a recommendation to modify an observation plan, a training plan, or an event record. In an exemplary embodiment, an additional operation may be included for providing a web page from which event data corresponding to different types of event records is accessible at each of the plurality of levels within the organization. In this regard, the different types of event records may include internally generated incident records, internally generated observation records, and externally generated citations.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for providing a safety management center, the method comprising:
receiving safety related event data via an event record that is customizable at a plurality of levels within an organization;
storing the event data;
generating a report based on the stored event data, the report being customizable at the plurality of levels within the organization; and
generating planning information for improving projected future reports, the planning information being capable of generation at each of the plurality of levels within the organization.

2. The method of claim 1, wherein receiving safety related event data comprises receiving event data from a source external to the organization.

3. The method of claim 2, further comprising providing the generated report to the source external to the organization.

4. The method of claim 3, wherein providing the generated report to a source external to the organization comprises providing the generated report to a regulatory agency, and wherein the event data is one of a citation or an inspection record.

5. The method of claim 1, wherein generating the report comprises generating trend data indicating rates of occurrence of event records.

6. The method of claim 1, wherein generating planning information comprises generating recommended modifications to a training plan.

7. The method of claim 1, wherein generating planning information comprises generating recommended modifications to an observation plan.

8. The method of claim 1, wherein generating planning information comprises generating recommended modifications to the event record.

9. The method of claim 8, wherein generating recommended modifications to the event record includes generating recommended changes to questions associated with the event record.

10. The method of claim 1, wherein storing the event data further comprises associating an identifier with the event data for indicating to a user whether certain fields of the event record have not received an input.

11. The method of claim 1, further comprising providing a web page from which event data corresponding to different types of event records is accessible at each of the plurality of levels within the organization, wherein the different types of event records include:
internally generated incident records;
internally generated observation records; and
externally generated citations.

12. A computer program product for providing a safety management center, the computer program product comprising at least one computer-readable storage medium having computer-readable program code portions stored therein, the computer-readable program code portions comprising:
a first executable portion receiving safety related event data via an event record that is customizable at a plurality of levels within an organization;
a second executable portion for storing the event data;
a third executable portion for generating a report based on the stored event data, the report being customizable at the plurality of levels within the organization; and
a fourth executable portion for generating planning information for improving projected future reports, the planning information being capable of generation at each of the plurality of levels within the organization.

13. The computer program product of claim 12, wherein the first executable portion includes instructions for receiving event data from a source external to the organization.

14. The computer program product of claim 13, further comprising a fifth executable portion for providing the generated report to the source external to the organization.

15. The computer program product of claim 14, wherein the fifth executable portion includes instructions for providing the generated report to a regulatory agency, and wherein the event data is one of a citation or an inspection record.

16. The computer program product of claim 12, wherein the third executable portion includes instructions for generating trend data indicating rates of occurrence of event records.

17. The computer program product of claim 12, wherein the fourth executable portion includes instructions for generating recommended modifications to a training plan.

18. The computer program product of claim 12, wherein the fourth executable portion includes instructions for generating recommended modifications to an observation plan.

19. The computer program product of claim 12, wherein the fourth executable portion includes instructions for generating recommended modifications to the event record.

20. The computer program product of claim 19, wherein the fourth executable portion includes instructions for generating recommended changes to questions associated with the event record.

21. The computer program product of claim 12, wherein the second executable portion includes instructions for associating an identifier with the event data for indicating to a user whether certain fields of the event record have not received an input.

22. The computer program product of claim 12, further comprising a fifth executable portion for providing a web page from which event data corresponding to different types of event records is accessible at each of the plurality of levels within the organization, wherein the different types of event records include:
internally generated incident records;
internally generated observation records; and
externally generated citations.

23. An apparatus for providing a safety management center, the apparatus comprising:
a communication element configured to receive safety related event data via an event record that is customizable at a plurality of levels within an organization;
a memory device in communication with the communication element for storing the event data;
a reporting element in communication with the memory device and configured to generate a report based on the stored event data, the report being customizable at the plurality of levels within the organization; and
a planning element in communication with the memory device and the reporting element and configured to generate planning information for improving projected future reports, the planning information being capable of generation at each of the plurality of levels within the organization.

24. The apparatus of claim 23, wherein the communication element is configured to receive event data from a source external to the organization.

25. The apparatus of claim 24, wherein the communication element is further configured to provide the generated report to the source external to the organization.

26. The apparatus of claim 25, wherein the communication element is further configured to provide the generated report to a regulatory agency, and wherein the event data is one of a citation or an inspection record.

27. The apparatus of claim 23, wherein the reporting element is further configured to generate trend data indicating rates of occurrence of event records.

28. The apparatus of claim 23, wherein the planning element is further configured to generate recommended modifications to a training plan.

29. The apparatus of claim 23, wherein the planning element is further configured to generate recommended modifications to an observation plan.

30. The apparatus of claim 23, wherein the planning element is further configured to generate recommended modifications to the event record.

31. The apparatus of claim 30, wherein the planning element is further configured to generate recommended changes to questions associated with the event record

32. The apparatus of claim 23, wherein the memory device is further configured to store the event data in association with an identifier for indicating to a user whether certain fields of the event record have not received an input.

33. The apparatus of claim 23, wherein the communication element is further configured to provide a web page from which event data corresponding to different types of event records is accessible at each of the plurality of levels within the organization, wherein the different types of event records include:
internally generated incident records;
internally generated observation records; and
externally generated citations.
